(19) United States
(12) Patent Application Publication
(10) Pub. No.: US 2019/0287418 A1
(43) Pub. Date: Sep. 19, 2019

(54) Class App

(71) Applicant: Anita Rabie, Stafford, TX (US)

(72) Inventor: Anita Rabie, Stafford, TX (US)

(21) Appl. No.: 16/072,808

(22) PCT Filed: Jan. 25, 2017
(86) PCT No.: PCT/US17/14890

§ 371 Date: Jul. 25, 2018

Related U.S. Application Data
(60) Provisional application No. 62/286,665, filed on Jan. 25, 2016.

(51) Int. Cl. G09B 19/00; G06F 16/95; H04L 29/08; G06F 3/0483

(52) U.S. Cl. CPC G09B 19/00; G06F 16/95; G06F 3/0483; H04L 67/306; H04L 67/10

(57) ABSTRACT

The present invention provides a means that will allow professionals including but not limited to beauty professionals and educators to connect with each other in the United States and all over the world and access various resources to advance their business and skills in their respective fields using a computer-implemented system or online platform. Some of the benefits of using this computer-implemented system or online platform include but are not limited to providing access to various courses, events, webinars, and classes and providing a forum for the beauty professionals to market their products and for the users of the computer-implemented system or online platform to leave any comments or suggestions.

### CROSS-REFERENCE TO RELATED APPLICATION

This non-provisional patent application claims the benefit of U.S. provisional patent application Ser. No. 62/286,665 filed on Jan. 25, 2016.

### FEDERAL FUNDING LEGEND

This invention was not created using federal funds.

### BACKGROUND OF THE INVENTION

### Field of the Invention

The present invention generally relates to a computer-implemented system that allows professionals in any field to connect with each other and access various resources to advance their business and skills in their respective fields. More specifically, in a preferred embodiment, the present invention is drawn to a computer-implemented system that allows beauty professionals and educators connect to each other in the United States and all over the world and access a variety of resources helpful in their fields.

Conventional computer-implemented systems do not have all the resources in one platform. Beauty educators do not have a convenient forum or platform that has all the features described herein that they can use to provide advice, educate or train the beauty professionals. Thus, there is a long-felt but significant and un-met need in the art for a computer-implemented or online means that has multiple functions including but not limited to connecting to other beauty professionals and educators, providing resources that allows the beauty professionals to advance their skills and promote their business, and providing a forum for professionals in this field to market and distribute their products. The present invention satisfies this long-standing need in the art.

### SUMMARY OF REPRESENTATIVE EMBODIMENTS OF THE INVENTION

In a preferred embodiment, the present invention is directed to a system for beauty professionals, comprising: at least one computer having at least one processor, a memory & a display connected to said processor, and at least one network connection; a server connected to the computer; an interactive tool connected to the computer, wherein said interactive tool comprises: more than one interactive module configured to receive, process, retrieve, send, or a combination thereof information pertaining to one or more beauty products, one or more beauty services, one or more beauty events, or a combination thereof; a database comprising one or more beauty products, one or more beauty services, one or more events or a combination thereof, wherein said database can be accessed by the module; and a user interface that is coupled to the module and database.

In a related embodiment, the user interface comprises a home module, a user module, an instructor module, an administrator module, a key board, a mouse, or a combination thereof.

In yet another related embodiment, the user module comprises: a login or register module configured for the user to access the system using an email address or social media or both, to authenticate login, to retrieve forgotten password, or a combination thereof, an account module configured to allow the user to invite friends using social media access, to invite friends, to edit profile, to change password, to tag favorites, to push notification settings, to obtain technical support, to logout, to review privacy policy, to review to review terms of use, to information about the website, to logout of the system, or a combination thereof; a search module configured to allow the user to search the database by keyword for beauty services, beauty products, beauty events, or a combination thereof, to review results of the search, or both; a events module configured to allow the user to view featured events list, to view events category list, to view events list with short description and image, to select event detailed page, to share on social media, to generate link and share option, to add to favorites, to register for events, or a combination thereof; or a combination thereof.

In still yet another related embodiment, the instructor module comprises: a register or login module configured to allow the instructor to sign in using an email address or via social media or both; to authenticate login, to retrieve forgotten password, or a combination thereof; an account module configured to allow the instructor to view profile, to edit profile, or both; to change password; to view events, to edit events, to delete events, to review how the system works, to review terms and policy, to logout or a combination thereof; a create event or courses module configured to allow the instructor to choose event category, to enter event title, to enter event description, to enter event venue, to upload photos, to remove photos, to submit details, to view events list with or without image with short description, to select event detailed page, to add to favorites, or a combination thereof; or a combination thereof.

In further yet another related embodiment, the administrator module comprises: an user management module configured to allow the administrator to login password, to change password, to view all users list, to add user list and details, to edit user list and details, to delete user list and details, to determine whether the account is active or inactive, or a combination thereof; an instructor management module configured to allow the administrator to view all instructors list, to add instructor list and details, to edit instructor list and details, to delete instructor list and details, to view selected instructor event details, to edit selected instructor list and details, to delete selected instructor event details, to determine whether the account is active or inactive, or a combination thereof; a content or category or event management module configured to allow the administrator to view event category list and details, to add event category list and details, to edit event category list and details, to delete event category list and details, to view all event list, to add event list and details, to edit event list and details, to delete event list and details, to approve instructor event details, to deny instructor event details, to determine whether the account is active or inactive, view content page details, to add content page details, to edit content page details, to delete content page details, to perform unit testing, to release procedure, or a combination thereof, or a combination thereof.

In still yet another related embodiment, the individual accessing the user module is a beauty professional.

In yet another related embodiment, the computer is a laptop machine or computer, a desktop machine or computer, a smart phone, a tablet computer, or similar device.

In another related embodiment, the beauty event comprises meeting, webinar, course, blog, sale of products, class, or a combination thereof.

In another preferred embodiment, the present invention is directed to a computer-implemented method for obtaining information regarding beauty products, beauty services, beauty events or a combination thereof, comprising: accessing the user interface of the interactive tool of the system described herein; accessing the user module of the user interface to log in to the system; searching the database for the beauty product, beauty service, beauty course, beauty events, beauty webinars, or a combination thereof; incorporating keywords to conduct the search; selecting the beauty product, the beauty service, the beauty course, the beauty event, the beauty webinar, or a combination thereof; saving the selected beauty product, the beauty service, the beauty course, the beauty event, the beauty webinar, or a combination thereof; registering for the beauty course, the beauty event, the beauty webinar or a combination thereof; accessing the user module to log out of the system; or a combination thereof.

In another preferred embodiment, the present invention is directed to a computer-implemented method for providing information regarding beauty products, beauty services, beauty events or a combination thereof, comprising: accessing the user interface of the interactive tool of the system described herein; accessing the instructor module of the user interface to log in to the system; accessing the create event module in the instructor module to choose event category, enter event title, enter event description, enter event venue, upload photos, remove photos, submit details, view events list with or without image with short description, select event detailed page, add to favorites, or a combination thereof; accessing the instructor module to log out of the system; or a combination thereof.

In yet another preferred embodiment, the present invention is directed to a computer-implemented method for managing information regarding beauty products, beauty services, beauty events or a combination thereof, comprising: accessing user interface of the interactive tool of the system described herein; accessing the administrator module of the user interface to log in to the system; accessing the user management module to login password, change password, view all users list, add user list and details, edit user list and details, delete user list and details, determine whether the account is active or inactive, or a combination thereof; accessing the instructor management module to view all instructors list, add instructor list and details, edit instructor list and details, delete instructor list and details, view selected instructor event details, edit selected instructor list and details, delete selected instructor event details, determine whether the account is active or inactive, or a combination thereof; accessing the content management module to view event category list and details, add event category list and details, edit event category list and details, delete event category list and details, view all event list, add event list and details, edit event list and details, delete event list and details, approve instructor event details, deny instructor event details, determine whether the account is active or inactive, view content page details, add content page details, edit content page details, delete content page details, perform unit testing, release procedure, or a combination thereof; accessing the administrator module to log out of the system; or a combination thereof.

### BRIEF DESCRIPTION OF THE DRAWINGS

FIG. 1 shows the flow chart of the modules in the user interface of the computer-implemented system of the present invention. It also shows the different modules within the main modules in the user interface.

FIGS. 2A-2D illustrate some of the embodiments described herein. FIG. 2A shows the homepage of the computer-implemented system with. FIG. 2B shows the page of the computer-implemented system that comprises discussions about the reasons to join the system and tools to subscribe to this system. FIG. 2C shows the page of the computer-implemented system that provides information regarding upcoming courses, classes, events, and webinars and tools to search for specific courses, classes, events and webinars. FIG. 2D shows the page of the computer-implemented system where users can subscribe to newsletter.

### DESCRIPTION OF PREFERRED EMBODIMENTS

The purpose of the invention is to connect the professionals and educators in any field with each other within the United States and all over the world. Preferably, the present invention provides a computer-implemented system to connect beauty professionals with beauty skill educators to advance their skills in their respective occupations and access courses for required credits per year. The computer-implemented system described herein will be very helpful to beauty professionals who forget to sign or search for classes and obtain the required credits yearly to maintain their licenses. Conventional online platform available in the market for beauty professionals does not comprise all the functions in one place as described herein.

The software for the computer-implemented system can be uploaded on devices that include but are not limited to desktops, laptops, iPads, iPhones and other related devices. The software is compatible with iOS or google. In yet another related embodiment, the computer-implemented system performs functions helpful for beauty professionals that include but are not limited to providing access and promotion to classes, special deals, class equipment, industry updates, blogs, or events.

In a preferred embodiment, the present invention discloses a system for beauty professionals. This system comprises at least one computer having at least one processor, a memory and a display connected to the processor, and at least one connection, a server connected to the computer, an interactive tool connected to the computer, where the interactive tool comprises at least one interactive module configured to receive, process, retrieve, send or a combination thereof, information pertaining to one or more beauty products, one or more beauty services, one or more beauty events, or a combination thereof; a database comprising one or more beauty products, one or more beauty services, one or more beauty events, or a combination thereof, where the database can be accessed using the interactive module; and a user interface that is coupled to the interactive module and the database. In a related embodiment, the user interface comprises a home module, a user module, an instructor module, an administrator module, a key board, a mouse, or a combination thereof. In another related embodiment, the home module comprises the index page content. In yet another related embodiment, the user module comprises a login or register module configured for the user to access the system using an email address or social media or both, to authenticate login, to retrieve forgotten password, or a combination thereof; an account module configured to allow the user to invite friends using social media access, to invite friends, to edit profile, to change password, to tag favorites, to push notification settings, to obtain technical support, to logout, to review privacy policy, to review to review terms of use, to information about the website, to logout of the system, or a combination thereof; a search module configured to allow the user to search the database by keyword for beauty services, beauty products, beauty events, or a combination thereof, to review results of the search, or both; an events module configured to allow the user to view featured events list, to view events category list, to view events list with short description and image, to select event detailed page, to share on social media, to generate link and share option, to add to favorites, to register for events, or a combination thereof; or a combination thereof.

Table 1 is an example of the tasks that will be performed by the user module, instructor module, administrator module of the user interface of this computer-implemented system.

TABLE 1

| S. N.o | Module | Sub Module | Task No | Task |
|---|---|---|---|---|
| 1 | User Module | Home | 1 | Index Page Content |
| | (Barber/Student) | Register/Login | 2 | Signup Using Email Address |
| | | | 3 | Facebook Login Option |
| | | | 4 | Login (Authentication) |
| | | | 5 | Forgot Password (Retrieve to Email Option) |
| | | My Account | 6 | Invite |
| | | | | Facebook Friend |
| | | | | Contacts |
| | | | 6 | Account |
| | | | | Edit Profile |
| | | | | Change Password |
| | | | | My Faves |
| | | | | Push Notification Settings |
| | | | 7 | Technical Support |
| | | | | FAQs |
| | | | | Report An Issue |
| | | | 8 | App Info |
| | | | | Privacy Policy |
| | | | | Terms |
| | | | | Website |
| | | | 9 | Logout |
| | | Search | 10 | Search by Keyword |
| | | | 11 | View Search Result |
| | | Events | 12 | View Featured Events List |
| | | | 13 | View Events Category List |
| | | | 14 | View Events List (Image with Short Description) |
| | | | 15 | Selected Event Detailed Page |
| | | | 16 | Share on Facebook, Twitter, Instagram, LinkedIn |
| | | | 17 | Generate Link & Share Option |
| | | | 18 | Add to Favorites |
| | | | 19 | Attend this Event (Fill & Submit Form) |
| 2 | Instructor | Register/Login | 20 | Signup Using Email Address |
| | Module | | 21 | Facebook Login Option |
| | | | 22 | Login (Authentication) |
| | | | 23 | Forgot Password (Retrieve to Email Option) |
| | | My Account | 24 | View/Edit Profile |
| | | | 25 | Change Password |
| | | | 26 | View/Edit/Delete Events |
| | | | 27 | How It Works |
| | | | 28 | Terms & Privacy |
| | | | 29 | Logout |
| | | Create Event/ | 30 | Choose Event Category |
| | | Courses | 31 | Enter Event Title |
| | | | 32 | Enter Event Description |
| | | | 33 | Enter Event Venue |
| | | | 34 | Upload/Remove Photos |
| | | | 35 | Submit Details |
| | | | 36 | View Events List (Image with Short Description) |
| | | | 37 | Selected Event Detailed Page |
| | | | 38 | Add to Favorites |
| 3 | Admin | Admin | 39 | Login-Change Password |
| | Module | User Management | 40 | View All Users List |
| | | (Barber/Student) | 41 | Add/Edit/Delete User List & Details |
| | | | 42 | Active/Inactive Option |
| | | Instructor | 43 | View All Instructors List |
| | | Management | 44 | Add/Edit/Delete Instructor List & Details |
| | | | 45 | View/Edit/Delete Selected Instructor Event Details |
| | | | 46 | Active/Inactive Option |
| | | Category Management | 47 | View/Add/Edit/Delete Category List & Details |
| | | Event | 48 | View All Event List |
| | | Management | 49 | Add/Edit/Delete Event List & Details |
| | | | 50 | Approve/Deny Instructor Event Details |
| | | | 51 | Active/Inactive Option |
| | | Content | 52 | View/Add/Edit/Delete Content Page Details |
| | | Management | 53 | Unit Testing |
| | | | 54 | Release Procedure |

For instance, the user can have customized profile when he uses this computer-implemented system. The user can login to the system using either social media such as Facebook or an email account or both. Further, the computer-implemented system will provide users with access to events that include but are not limited to courses, classes that include but are not limited to hands on classes, look and learn classes, meetings, webinars, and blogs in their respective field. The classes, courses or webinars may include but are not limited to basic, intermediate or advance classes or webinars or a combination thereof either live or recorded. Additionally, the computer-implemented system provides users with information regarding the class and webinar that includes but is not limited to information regarding details pertaining to the class instructor and webinar speaker including but not limited to the education and experience of the instructor or speaker, and details pertaining to the class that include but are not limited to the availability, location, schedule or combination thereof. Further, the computer-implemented system allows the user to see which other professional is attending the class, webinar or event that they have signed up for. Still further, the course instructor, webinar instructor or any other beauty professional using this computer-implemented system can message other professional. Still further, the computer-implemented system is linked to the beauty professional's license and regulations department to provide the professionals with information including but not limited to their credit requirement and eligibility, and to other registered beauty professionals. Additionally, the computer-implemented system provides a live calendar that provides the user with means to send invites for several events including but not limited to networking events, meetings, events, webinars, classes or courses and accept these invites; Further, the computer-implemented system provides reminders or real time alerts that include but are not limited to information regarding upcoming classes, events, webinars, or product sales through means that include but are not limited to email, text, or calendar alert.

Still further, the computer-implemented system provides user with tools to market their business including but not limited to advertising products or classes. Further yet, the computer-implemented system allows the users to buy the beauty products including but not limited to salon tools advertised on the platform. The users of this computer-implemented system include but are not limited to beauty professionals, vendors, barbers, students who are enrolled in beauty courses or barber courses, instructors, administrators of the computer-implemented system. Additionally, the users of the computer-implemented system can share or exchange tips or advice with other users of this computer-implemented system or leave any comments or suggestions for the administrators of this computer-implemented system.

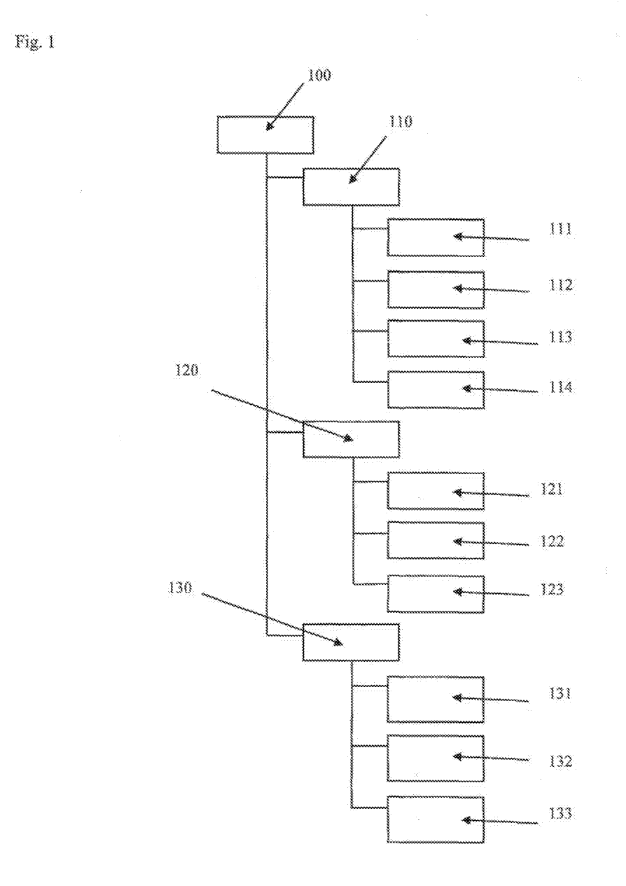

FIG. 1 shows the flow diagram for the different modules that comprise the user interface. As shown in FIG. 1, the user interface comprises home (#100), user module (#110), instructor module (#120), and administrator module (#130). The user module (#110) further comprises login or register module (#111), my account module (#112), search module (#113), and events module (#114). The instructor module (#120) further comprises login or register module (#121), my account module (#122), and create event module (#123). The administrator module (#130) further comprises user management module (#131) to manage beauty professional or student account, instructor management module (#132) to manage instructor account, and content management module (#133) to manage the content of the computer-implemented system.

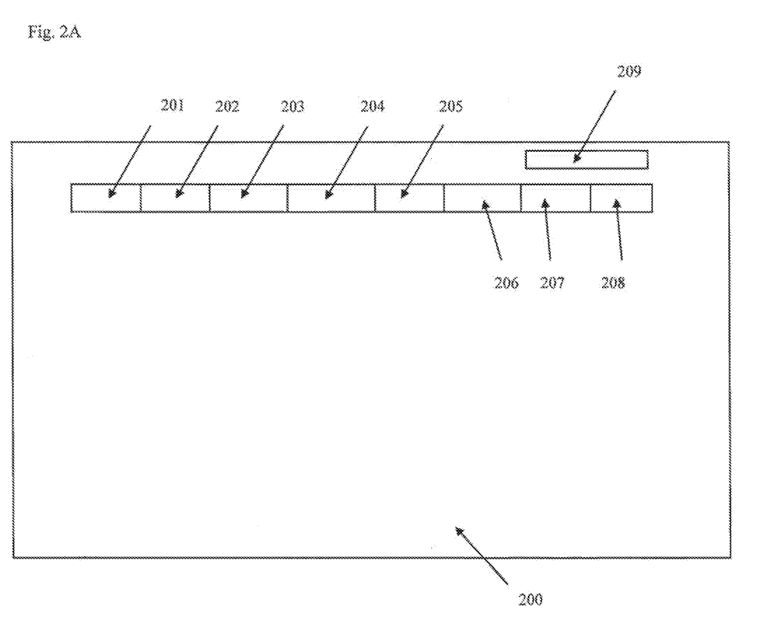

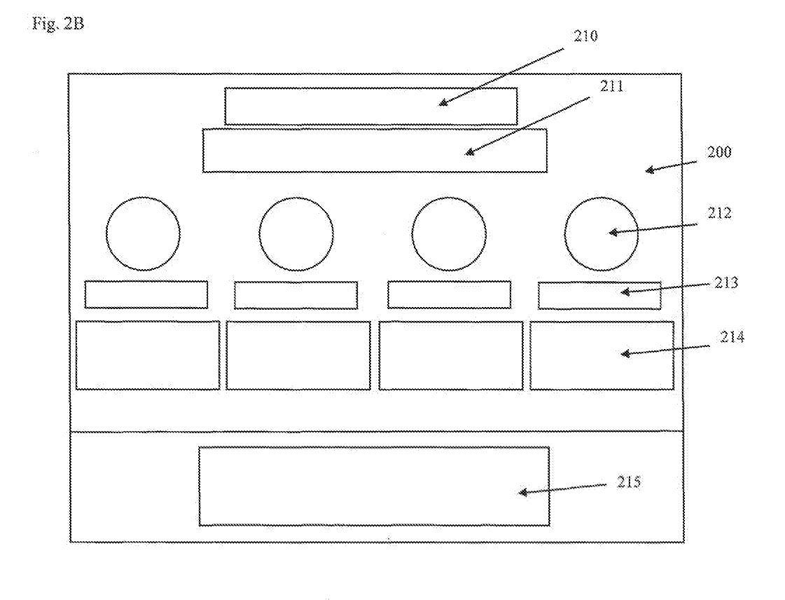

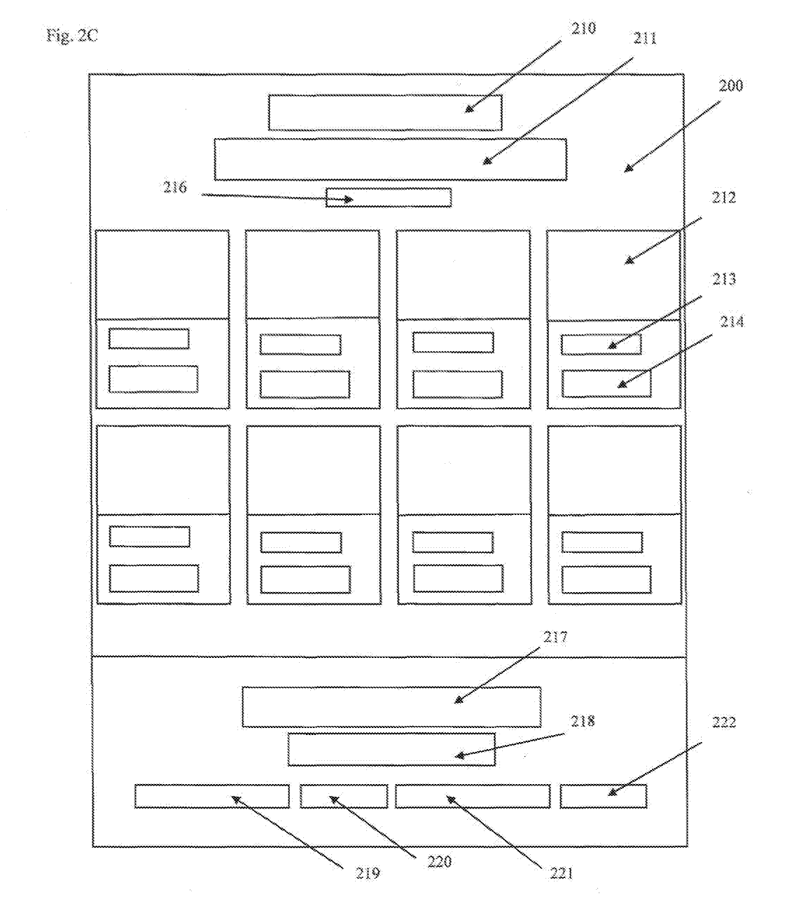

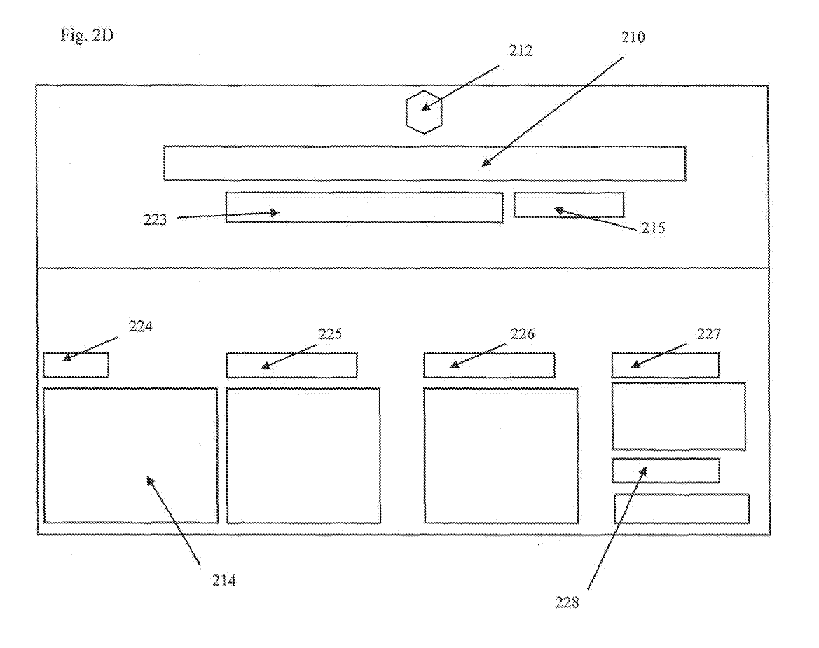

FIGS. 2A-2D illustrate some of the embodiments described herein. FIG. 2A shows the homepage of the computer-implemented system with. The homepage (#200) in this figure comprises a home module (#201), an about module (#202) that provides more information about the webpage, a courses module (#203) that describes the courses that are available, a tutorials module (#204) that describes the tutorials that are available, a blog module (#205), a contact module (#206), a sign in module (#207), a sign up module (#208), and a search module (#209).

FIG. 2B shows the page (#200) of the computer-implemented system that comprises discussions about the reasons to join the system and tools to subscribe to this system. For instance, this webpage (#200) comprises title module (#210) that describes the contents of the page (#200), description module (#211) that describes the webpage (#200), image module (#212) that provide images for different categories listed on this page (#200), title module (#213) under the image module (#212) that provides titles of the different categories, description module (#214) under the image module (#212) that describes the categories, and subscription module (#215) that provides tool to subscribe to this page. For instance, if the page (#200) is advertising reasons to subscribe to the computer-implemented system, the title module (#210) will describe the title of the page, the description module (#211) will describe why one should subscribe to this computer implemented system, the images module (#212) will have images for different categories, including but not limited to expert professionals, over 100 courses, certified courses, and online tutorials. Additionally, the title module (#213) and the description module (#214) will describe these categories. There is a subscription module (#215) at the bottom of the page (#200) that will allow users to subscribe to the computer-implemented system.

FIG. 2C shows the page of the computer-implemented system that provides information regarding upcoming courses, classes, events, and webinars and tools to search for specific courses, classes, events and webinars. In this figure, the webpage (#200) comprises a title module (#210) at the top of the webpage (#200), a description module (#211) underneath the title module (#210), a browse module (#216), at least one image module (#212) for the different categories listed on the page (#200), title module (#213) underneath the image module (#212) and description module (#214) underneath the title module (#213) related to the categories. At the bottom of the page, there are tools to search the different categories in the computer-implemented system, that comprises title module (#217) for the search tool, instructions module (#218), category module (#219), type module (#220), keywords (#221), and search module (#222). For instance, if the webpage (#200) describes the different courses available in the computer-implemented system, title module (#210) at the top of the webpage (#200) will disclose that this page (#200) is about latest courses, a description module (#211) underneath the title module (#210) will provide brief description of this page (#200), a browse module (#216) will allow the user to browse the courses, at least one image module (#212) for the different courses listed on the page (#200), title module (#213) underneath the image module (#212) and description module (#214) underneath the title module (#213) related to the courses. At the bottom of the page, there are tools to search the different categories in the computer-implemented system, that comprises title module (#217) for the search tool, instructions module (#218), category module (#219), type module (#220), keywords (#221), and search module (#222).

FIG. 2D shows the page of the computer-implemented system where users can subscribe to newsletter. The webpage (#200) of the computer-implemented system comprises image module (#212), title module (#210) that discloses the title of the page (#200), email module (#223) where the user can provide email information, subscribe module (#215), about us module (#224) that describes the computer-implemented system, recent courses module (#225) that provides information regarding the courses, recent tutorials module (#226) that provides information regarding the recent tutorials, contacts module (#227) that provides information regarding individuals that the user can contact, description module (#214) underneath the different categories listed on the page (#200) that describes the different modules, social media module (#228) that provides tools for the user to follow the computer-implemented system on social media.

In another related embodiment, the instructor module comprises: a register or login module configured to allow the instructor to sign in using an email address or via social media or both; to authenticate login, to retrieve forgotten password, or a combination thereof, an account module configured to allow the instructor to view profile, to edit profile, or both; to change password; to view events, to edit events, to delete events, to review how the system works, to review terms and policy, to logout or a combination thereof, a create event or courses module configured to allow the instructor to choose event category, to enter event title, to enter event description, to enter event venue, to upload photos, to remove photos, to submit details, to view events list with or without image with short description, to select event detailed page, to add to favorites, or a combination thereof; or a combination thereof.

In yet another related embodiment, wherein the administrator module comprises: a user management module configured to allow the administrator to login password, to change password, to view all users list, to add user list and details, to edit user list and details, to delete user list and details, to determine whether the account is active or inactive, or a combination thereof; an instructor management module configured to allow the administrator to view all instructors list, to add instructor list and details, to edit instructor list and details, to delete instructor list and details, to view selected instructor event details, to edit selected instructor list and details, to delete selected instructor event details, to determine whether the account is active or inactive, or a combination thereof; a content or category or event management module configured to allow the administrator to view event category list and details, to add event category list and details, to edit event category list and details, to delete event category list and details, to view all event list, to add event list and details, to edit event list and details, to delete event list and details, to approve instructor event details, to deny instructor event details, to determine whether the account is active or inactive, view content page details, to add content page details, to edit content page details, to delete content page details, to perform unit testing, to release procedure, or a combination thereof; or a combination thereof.

In another related embodiment, the individual accessing the user module is a beauty professional. This beauty professional may include but is not limited to a barber, a beauty technician, a student enrolled in school or training to be a barber, a student enrolled in school or training to be a beauty professional.

In yet another preferred embodiment, the computer is a laptop machine or computer, a desktop machine or computer, a smart phone, a tablet computer, or similar device. In yet another related embodiment, the beauty event comprises meeting, webinar, course, blog, sale of products, class, or a combination thereof.

Table 2 shows an example of the technology that was used in the computer-implemented system.

| Technology Stack | Platform |
|---|---|
| Framework | Ionic |
| Database | MySQL |
| Markup Language | HTML/CSS |
| Client Side | Angular JS, JQuery, JavaScript |
| Server Side Scripting Language | PHP, Angular JS |
| Operating System | MAC/Windows |
| Web Server | Apache |

In another preferred embodiment, the computer-implemented system described herein allows users to obtain beauty products, beauty services, beauty events or a combination thereof. In this regard, the present invention discloses a computer-implemented method for obtaining information regarding beauty products, beauty services, beauty events or a combination thereof, comprising: accessing the user interface of the interactive tool of the system described above; accessing the user module of the user interface to log in to the system; searching the database for the beauty products, beauty services, beauty events, or a combination thereof; incorporating keywords to conduct the search; selecting the beauty product, the beauty service, the beauty event, or a combination thereof; saving the selected beauty product, the beauty service, the beauty event, or a combination thereof, registering for the beauty service, registering for the beauty event, purchasing the beauty product, or a combination thereof; accessing the user module to log out of the system; or a combination thereof.

In yet another preferred embodiment, the computer-implemented system allows the instructors to provide information regarding beauty products, beauty services, beauty events, or a combination thereof. In this regard, the present invention discloses a computer-implemented method for providing information regarding beauty products, beauty services, beauty events or a combination thereof, comprising: accessing the user interface of the interactive tool of the system described above; accessing the instructor module of the user interface to log in to the system; accessing the create event module in the instructor module to choose event category, enter event title, enter event description, enter event venue, upload photos, remove photos, submit details, view events list with or without image with short description, select event detailed page, add to favorites, or a combination thereof; accessing the instructor module to log out of the system; or a combination thereof.

In yet another preferred embodiment, the information on the computer-implemented system is managed by the administrator of the system. In this regard, the present invention discloses a computer-implemented method for managing information regarding beauty products, beauty services, beauty events or a combination thereof, comprising: accessing user interface of the interactive tool of the system described herein; accessing the administrator module of the user interface to log in to the system; accessing the user management module to login password, change password, view all users list, add user list and details, edit user list and details, delete user list and details, determine whether the account is active or inactive, or a combination thereof; accessing the instructor management module to view all instructors list, add instructor list and details, edit instructor list and details, delete instructor list and details, view selected instructor event details, edit selected instructor list and details, delete selected instructor event details, determine whether the account is active or inactive, or a combination thereof; accessing the content management module to view event category list and details, add event category list and details, edit event category list and details, delete event category list and details, view all event list, add event list and details, edit event list and details, delete event list and details, approve instructor event details, deny instructor event details, determine whether the account is active or inactive, view content page details, add content page details, edit content page details, delete content page details, perform unit testing, release procedure, or a combination thereof; accessing the administrator module to log out of the system; or a combination thereof.

The features described herein are the preferred embodiments and do not restrict the makings of the computer-implemented system described herein. Thus, the computer-implemented system can be implemented using any type of compiler and any type of computer hardware system, network system, or other platform. As used herein, the term “computer hardware system” is intended to include all the necessary components of a computer system that are required to run or execute a source program and that allow someone to use the computer. By way of non-limiting example, the hardware components include, but are not limited to, a power supply, motherboard, hard disk, graphics card, Random access memory (RAM), and other hardware components. Additional hardware components can include, for instance, a keyboard, mouse, speakers, etc.

It is contemplated that the methods of the present invention can therefore be implemented by operation of any type of computer system that includes computer components including but not limited to a processor, memory storage devices for the processor, connected display devices, and input devices. Furthermore, the methods of the present invention can be implemented by operation of computer components in a heterogenous distributed computing environment, including for example one or more remote file servers, computer servers, and/or memory storage devices. Each of these distributed computing components is accessible by the processor via a communication network, which may include but is not limited to, the Internet.

The computer-implemented system described herein is unique because it provides essential tools that are required for professionals, for instance, a beauty professional in one place. The beauty professional can connect to educators in her field and seek advice, guidance or education to advance her skill. She can also use this forum to advertise her business to other professionals. She can use this forum to market her products to other beauty professionals. More importantly, this forum will allow her to connect to beauty professionals within the United States and all over the world.

As used herein, the term “user interface” refers to one or more tools that allow the user to communicate with the operating system. The examples of the user interface include but are not limited to a home module, a user module, an instructor module, an administrator module, a key board, a mouse, or a combination thereof.

It is to be understood that the term “user” shall include, but is not limited to, (i) a provider of beauty services (including, by way of example, a beauty professional), (ii) an instructor who instructs or educates a provider of beauty services; or (iii) an administrator who manages a computer-implemented system or online platform as described herein.

The foregoing descriptions of the embodiments of the present invention have been presented for purposes of illustration and description. They are not intended to be exhaustive or to limit the present invention to the precise forms disclosed. The exemplary embodiments were chosen and described in order to best explain the principles of the present invention and its practical application, to thereby enable others skilled in the art to best utilize the present invention.

What is claimed is:

1. A system for beauty professionals, comprising:
at least one computer having at least one processor, a memory and a display connected to said processor, and at least one network connection;
a server connected to the computer;
an interactive tool connected to the computer, wherein said interactive tool comprises:
more than one interactive module configured to receive, process, retrieve, send, or a combination thereof information pertaining to one or more beauty products, one or more beauty services, one or more beauty events, or a combination thereof;
a database comprising one or more beauty products, one or more beauty services, one or more events or a combination thereof, wherein said database can be accessed by the module; and
a user interface that is coupled to the module and database.

2. The system of claim 1, wherein the user interface comprises a home module, a user module, an instructor module, an administrator module, a key board, a mouse, or a combination thereof.

3. The system of claim 2, wherein the user module comprises:
a login or register module configured for the user to access the system using an email address or social media or both, to authenticate login, to retrieve forgotten password, or a combination thereof;
an account module configured to allow the user to invite friends using social media access, to invite friends, to edit profile, to change password, to tag favorites, to push notification settings, to obtain technical support, to logout, to review privacy policy, to review terms of use, to get information about the website, to logout of the system, or a combination thereof;
a search module configured to allow the user to search the database by keyword for beauty services, beauty products, beauty events, or a combination thereof, to review results of the search, or both;
an events module configured to allow the user to view a featured events list, to view an events category list, to view an events list with short description and image, to select an event detailed page, to share on social media, to generate a link and share option, to add to favorites, to register for events, or a combination thereof;
or a combination thereof.

4. The system of claim 2, wherein the instructor module comprises:
a register or login module configured to allow the instructor to sign in using an email address or via social media or both; to authenticate login, to retrieve forgotten password, or a combination thereof;
an account module configured to allow the instructor to view profile, to edit profile, or both; to change password; to view events, to edit events, to delete events, to review how the system works, to review terms and policy, to logout or a combination thereof,
a create event or courses module configured to allow the instructor to choose event category, to enter event title, to enter event description, to enter event venue, to upload photos, to remove photos, to submit details, to view events list with or without image with short description, to select event detailed page, to add to favorites, or a combination thereof;
or a combination thereof.

5. The system of claim 2, wherein the administrator module comprises:
a user management module configured to allow the administrator to login password, to change password, to view all users list, to add user list and details, to edit user list and details, to delete user list and details, to determine whether the account is active or inactive, or a combination thereof;
an instructor management module configured to allow the administrator to view all instructors list, to add instructor list and details, to edit instructor list and details, to delete instructor list and details, to view selected instructor event details, to edit selected instructor list and details, to delete selected instructor event details, to determine whether the account is active or inactive, or a combination thereof;
a content or category or event management module configured to allow the administrator to view event category list and details, to add event category list and details, to edit event category list and details, to delete event category list and details, to view all event list, to add event list and details, to edit event list and details, to delete event list and details, to approve instructor event details, to deny instructor event details, to determine whether the account is active or inactive, view content page details, to add content page details, to edit content page details, to delete content page details, to perform unit testing, to release procedure, or a combination thereof;
or a combination thereof.

6. The system of claim 2, wherein an individual accessing the user module is a beauty professional.

7. The system of claim 1, wherein the computer is a laptop machine or computer, a desktop machine or computer, a smart phone, a tablet computer, or similar device.

8. The system of claim 1, wherein the beauty event comprises a meeting, webinar, course, blog, sale of products, class, or a combination thereof.

9. A computer-implemented method for obtaining information regarding beauty products, beauty services, beauty events or a combination thereof, comprising:
accessing the user interface of the interactive tool of the system of claim 1;
accessing the user module of the user interface to log in to the system;
searching the database for the beauty product, beauty service, beauty course, beauty events, beauty webinars, or a combination thereof;
incorporating keywords to conduct the search;
selecting the beauty product, the beauty service, the beauty course, the beauty event, the beauty webinar, or a combination thereof;
saving the selected beauty product, the beauty service, the beauty course, the beauty event, the beauty webinar, or a combination thereof;
registering for the beauty course, the beauty event, the beauty webinar or a combination thereof;
accessing the user module to log out of the system; or a combination thereof.

10. A computer-implemented method for providing information regarding beauty products, beauty services, beauty events or a combination thereof, comprising:
accessing the user interface of the interactive tool of the system of claim 1;
accessing the instructor module of the user interface to log in to the system;
accessing the create event module in the instructor module to choose an event category, enter event title, enter event description, enter event venue, upload photos, remove photos, submit details, view events list with or without image with short description, select event detailed page, add to favorites, or a combination thereof;
accessing the instructor module to log out of the system; or a combination thereof.

11. A computer-implemented method for managing information regarding beauty products, beauty services, beauty events or a combination thereof, comprising:
accessing user interface of the interactive tool of the system of claim 1;
accessing the administrator module of the user interface to log in to the system;
accessing the user management module to login password, change password, view all users list, add user list and details, edit user list and details, delete user list and details, determine whether the account is active or inactive, or a combination thereof;
accessing the instructor management module to view all instructors list, add instructor list and details, edit instructor list and details, delete instructor list and details, view selected instructor event details, edit selected instructor list and details, delete selected instructor event details, determine whether the account is active or inactive, or a combination thereof;
accessing the content management module to view event category list and details, add event category list and details, edit event category list and details, delete event category list and details, view all event list, add event list and details, edit event list and details, delete event list and details, approve instructor event details, deny instructor event details, determine whether the account is active or inactive, view content page details, add content page details, edit content page details, delete content page details, perform unit testing, release procedure, or a combination thereof;
accessing the administrator module to log out of the system; or a combination thereof.
